(19) United States
(12) Patent Application Publication
(10) Pub. No.: US 2008/0242130 A1
(43) Pub. Date: Oct. 2, 2008

(54) METHODS AND APPARATUS FOR BATTERY CONTACT ASSEMBLY

(76) Inventor: Cyrus R. Etemad-Moghadam, Fallston, MD (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/045,959

(22) Filed: Mar. 11, 2008

Related U.S. Application Data
(60) Provisional application No. 60/909,570, filed on Apr. 2, 2007.

(51) Int. Cl. H01R 13/00; H01M 6/00; H01R 43/16; H01R 13/625

(52) U.S. Cl. 439/131; 29/623.1; 29/874; 439/341

(57) ABSTRACT

Methods and apparatus for a batter contact assembly having a compact profile for efficient use of space and reliable battery connections. In one embodiment, the assembly is of unitary construction with hinges and engagement mechanism to facilitate installation of the assembly into a device requiring battery power.

### CROSS REFERENCE TO RELATED APPLICATIONS

The present application claims the benefit of U.S. Patent Application No. 60/909,570, filed on Apr. 2, 2007, which is incorporated herein by reference.

### STATEMENT REGARDING FEDERALLY SPONSORED RESEARCH

The Government may have certain rights in the invention pursuant to Contract No. W15P7T-04-C-K402.

### BACKGROUND

As is known in the art, many electronic devices and systems have limited space and weight requirements. Such devices can include batteries to provide power. To provide these devices, it is often necessary to fabricate custom batteries and/or battery contact assemblies. These assemblies can have numerous parts requiring significant cost and effort in assembling the final device. In addition, multi-part assemblies may be susceptible to environmental degradation due to leaks, humidity, etc.

FIGS. 1A and 1B show a prior art battery contact assembly 10 having angled metal contacts 12 coupled to a plastic insulator 14 with metal holders 16. The assembly 10 is screwed to another assembly forming a part of a structure to hold one or more batteries. The battery contact assembly 10 also includes a separate metal contact 18 coupled to another plastic insulator 20. While this configuration may provide a relatively low profile, there are many parts, some of which are quite small and/or thin, that render assembly difficult. In addition, the completed assembly is less than rugged.

### SUMMARY

The present invention provides methods and apparatus for a low profile battery contact assembly. In one embodiment, the batter contact assembly is formed from a single piece of insulative material having a first hinge to interconnect first and second portions of the assembly and a second hinge to interconnect the second portion and a third portion. With this arrangement, the battery contact assembly can be readily inserted into a device after which a battery can be installed into the assembly.

In one aspect of the invention, an apparatus comprises a battery contact assembly including interconnected first, second, and third portions, the battery contact assembly having a first position in which the assembly is generally flat and having a second position in which the assembly is generally U-shaped, the first portion including a positive battery contact and the third portion including a negative battery contact.

In another aspect of the invention, a device powered by a battery comprises a battery contact assembly including interconnected first, second, and third portions, the battery contact assembly having a first position in which the assembly is generally flat and having a second position in which the assembly is generally U-shaped, the first portion including a positive battery contact and the third portion including a negative battery contact.

In a further aspect of the invention, a method comprises forming a battery contact assembly including interconnected first, second, and third portions, the battery contact assembly having a first position in which the assembly is generally flat and having a second position in which the assembly is generally U-shaped, the first portion including a positive battery contact and the third portion including a negative battery contact.

### BRIEF DESCRIPTION OF THE DRAWINGS

The foregoing features of this invention, as well as the invention itself, may be more fully understood from the following description of the drawings in which:

FIGS. 1A and 1B show pictorial representations of a prior art assembly to contact a battery;

FIGS. 2A and 2B are pictorial representations of a battery contact assembly in accordance with exemplary embodiments of the invention;

FIG. 3A is a pictorial representation of the battery contact assembly of FIG. 2 in a first position;

FIG. 3B is a top view of the battery contact assembly of FIG. 3A;

FIG. 3C is a side view of the battery contact assembly of FIG. 3A;

FIG. 4A is a side view of the battery contact assembly of FIGS. 2A and 2B

FIG. 4B is a front view of the battery contact assembly of FIGS. 2A and 2B;

FIGS. 5A and 5B are a pictorial representation of a device having a battery contact assembly in accordance with exemplary embodiments of the invention;

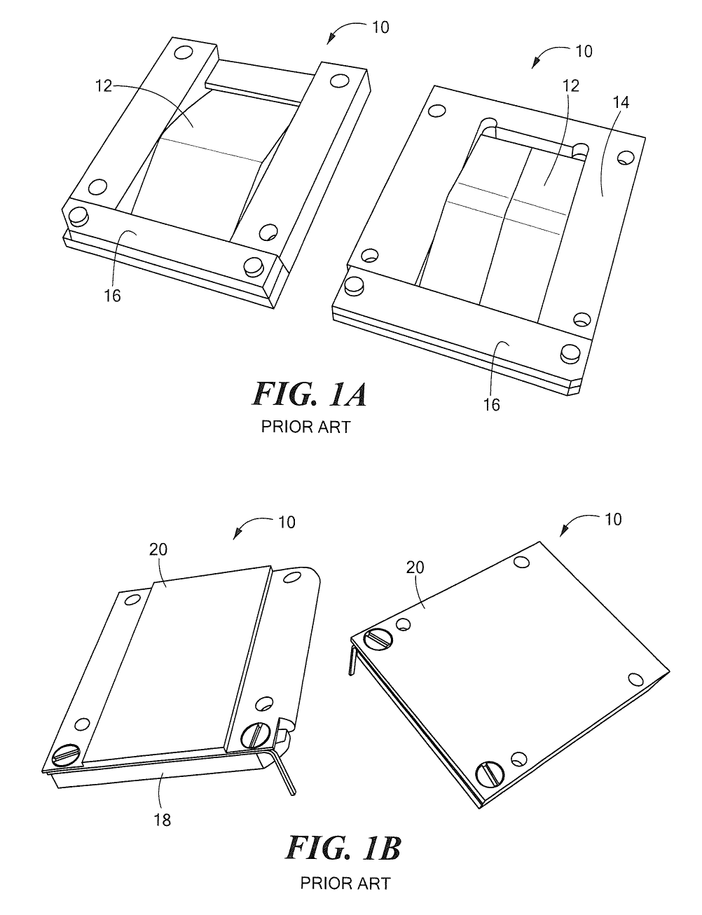

### DETAILED DESCRIPTION

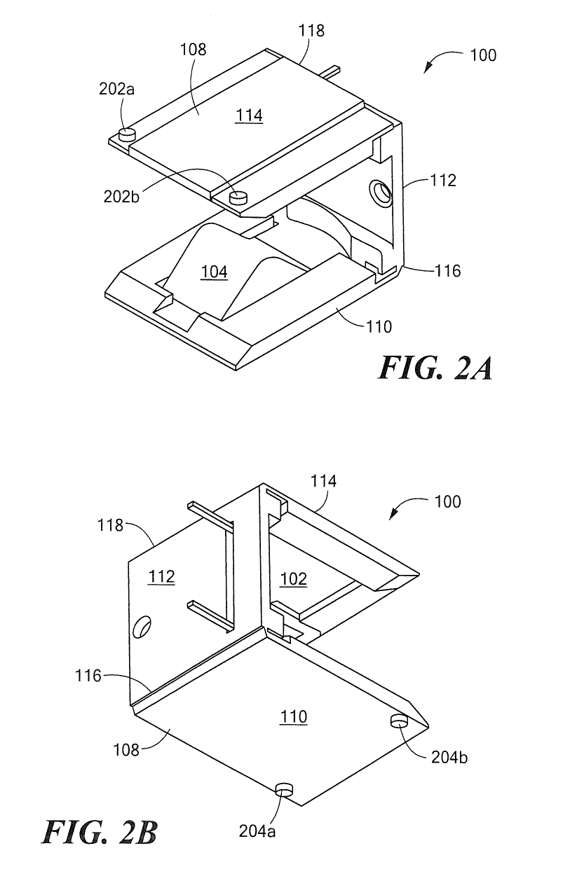

FIGS. 2A and 2B show a low profile battery contact assembly 100 having a first contact mechanism 102 and a second contact mechanism 104 for providing electrical connections for a battery in accordance with exemplary embodiments of the invention. In one embodiment, the first contact 102 provides an electrical connection to a first, e.g., positive, terminal of a battery and the second contact 104 provides an electrical connection to a second, e.g., negative, terminal of a battery.

In the illustrated embodiment, the battery contact assembly 100 includes a housing 108 having first, second and third portions 110, 112, 114, interconnected at respective first and second pivot regions 116, 118. It is understood that the pivot regions 116, 118 should be construed to allow movement of one portion of the housing with respect to a connected portion.

In one particular embodiment, the housing 108 is formed from a single piece of material, such as from a mold. The housing 102 material is a flexible insulator, such as plastic, in which hinges can be formed to provided the respective first and second pivot regions 116, 118. With this arrangement, the housing 108 can be molded as a generally flat piece of material that can be folded at the pivot regions 116, 118 to provide a three-sided enclosure to securely contain the battery/batteries. The contacts 102, 104 can be secured to the housing 108 using a variety of techniques well known to one of ordinary skill in the art. In one particular embodiment, the contacts are hot-staked to the plastic housing. In an alternative embodiment, the contacts can be snapped onto the housing.

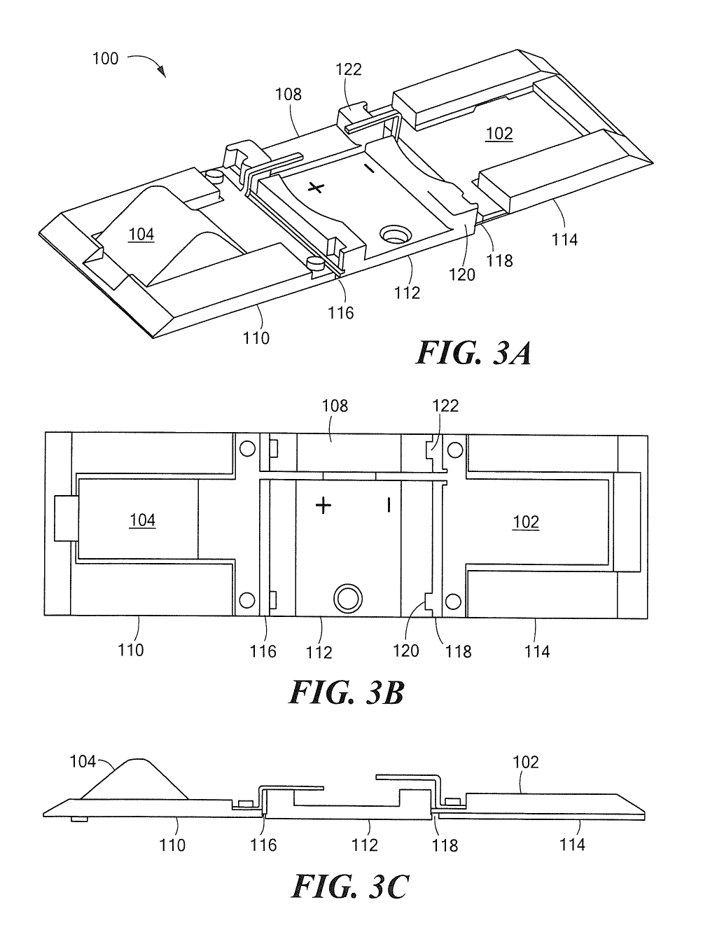

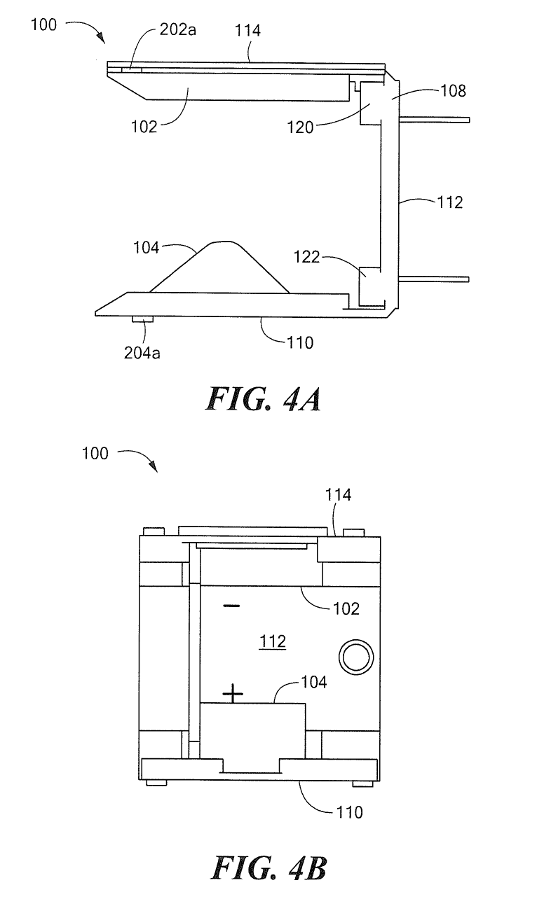

FIGS. 3A, 3B, and 3C show the battery contact assembly in a flat, non-use position. It will be readily appreciated that this position facilitates shipping and storage of the assembly 100. FIGS. 4A and 4B shows the battery contact assembly 100 in a use position configured to receive a battery. In the illustrated embodiment, the first, second, and third housing portions 110, 112, 114 provide three sides of a rectangular shape about the battery. The first portion 110 manipulated to be generally perpendicular to the second portion 112. Similarly, the third portion 114 is manipulated to be generally perpendicular to the second portion 112, such that a U-shape is formed.

In an exemplary embodiment, the second portion 112 includes first and second stops 120, 122 to prevent the first and third portions 110, 114 from folding in more than about ninety degrees with respect to the second portion 112. In the use position, where the first, second, and third portions generally form a U-shape, the assembly can be inserted into a device with relative ease, as described more fully below.

In an exemplary embodiment, the first contact 102 is a generally flat conductor, such as metal, secured to the third housing portion 114. The second conductor 104 is a generally arcuate conductor, such as metal secured to the first housing portion 110. The arcuate shape of the contact 102 enables a battery to be inserted into the assembly 100 with reliable electrical connections between the battery ends and the first and second contacts 102, 104. The second contact 104 deforms and biases the battery to the first contact 102.

It is understood that a variety of geometries and dimensions for the contacts can be used to meet the needs of a particular application. In addition, any practical number of contacts can be provided to receive corresponding batteries.

In another aspect of the invention, and referring again to FIGS. 2A and 2B, the housing includes at least one attachment mechanism to engage a complementary mechanism on the device to secure the battery contact housing 100 to the device. In one embodiment, the attachment mechanism includes first and second protrusions 202a,b on an outer surface of the third housing portion 114 and third and fourth protrusions 204a,b on an outer surface of the first housing portion 110. The protrusions 202, 204 snap into undercuts in a corresponding structure in the device. The protrusions 202, 204 provide uni-directional movement of the assembly into the device. That is, the snap-fit of the assembly 100 into the device in a first direction is not readily reversible due to the configuration of the protrusions 202, 204 and the undercuts. In alternative embodiments, slots and/or holes can be used in place of undercuts. With this arrangement, the attachment mechanism securely engages the battery contact assembly 100 to the device without the need of any additional hardware.

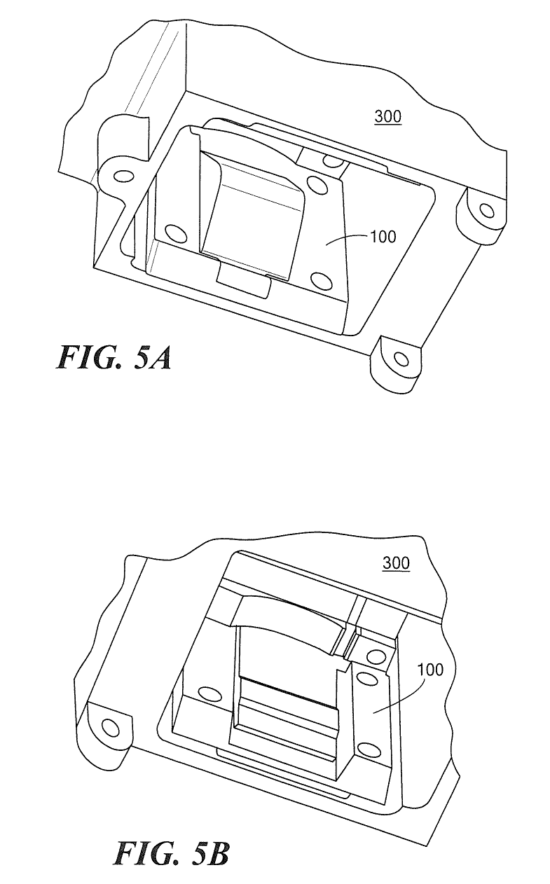

FIGS. 5A and 5B show a pictorial representation of a battery contact assembly 100 captured in a device 300 that requires battery power. The battery contact assembly 100 is configured to the U-shape position and pushed into the device 300 until the attachment mechanism, such as protrusions 202, 204, engage a corresponding structure, such as undercuts 350, in the device housing.

It is understood that a variety of suitable attachment mechanisms can be used to couple the battery contact assembly to the device will be apparent to one of ordinary skill in the art. Exemplary alternative mechanisms include snaps, detents, hook and loop, and the like.

While exemplary embodiments of the invention are shown and described herein, it is understood that various modifications to meet the needs of a particular application will be readily apparent to one of ordinary skill in the art. For example, while a U-shape position is shown, it is understood that other shapes can be provided in further embodiments, such as C-shapes, and other suitable configurations that can effectively receive a battery. Alternative insulator materials to plastic will be readily apparent for the housing portions. Materials can be selected for rigidity, cost, environmental conditions, and other factors.

The exemplary embodiments of the invention provide a battery contact assembly having a low profile that can be assembled and inserted into a device with relative ease. An integral housing, for example, can be injection molded with living hinges provided to allow the assembly to easily manipulated for facilitating insertion into a device. As described above, an exemplary battery contact assembly can be inserted into a device without the need for an installation tool.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. An apparatus, comprising:
a battery contact assembly including interconnected first, second, and third portions, the battery contact assembly having a first position in which the assembly is generally flat and having a second position in which the assembly is generally U-shaped, the first portion including a positive battery contact and the third portion including a negative battery contact.

2. The apparatus according to claim 1, wherein the battery contact assembly is of unitary construction with a first hinge formed at an intersection of the first and second portions.

3. The apparatus according to claim 2, wherein the battery contact assembly includes a second hinge formed at an intersection of the second and third portions.

4. The apparatus according to claim 1, wherein the negative battery contact includes a conductive layer that is deflectable to provide reliable contact with a battery.

5. The apparatus according to claim 1, further including a first attachment mechanism to secure the battery contact assembly to a device.

6. The apparatus according to claim 5, wherein the first attachment mechanism includes one or more protrusions for a snap fit into a receiving structure in the device.

7. The apparatus according to claim 6, wherein the snap fit is unidirectional.

8. The apparatus according to claim 1, wherein the first, second, and third portions are formed from a single piece of insulative material.

9. The apparatus according to claim 8, wherein the insulative material is injection molded.

10. The apparatus according to claim 1, wherein the second portion is contoured to a battery shape.

11. A device powered by a battery, comprising:
a battery contact assembly including interconnected first, second, and third portions, the battery contact assembly having a first position in which the assembly is generally flat and having a second position in which the assembly is generally U-shaped, the first portion including a positive battery contact and the third portion including a negative battery contact.

12. The device according to claim 11, wherein the battery contact assembly is of unitary construction with a first hinge formed at an intersection of the first and second portions.

13. The device according to claim 12, wherein the battery contact assembly includes a second hinge formed at an intersection of the second and third portions.

14. The device according to claim 11, wherein the negative battery contact includes a conductive layer that is deflectable to provide reliable contact with a battery.

15. The device according to claim 11, further including a first attachment mechanism to secure the battery contact assembly to a device.

16. The device according to claim 11, wherein the first, second, and third portions are formed from a single piece of insulative material.

17. A method, comprising:
forming a battery contact assembly including interconnected first, second, and third portions, the battery contact assembly having a first position in which the assembly is generally flat and having a second position in which the assembly is generally U-shaped, the first portion including a positive battery contact and the third portion including a negative battery contact.

18. The method according to claim 17, further including forming the battery contact assembly from a single piece of insulative material with a first hinge formed at an intersection of the first and second portions.

19. The method according to claim 17, further including providing a first attachment mechanism to secure the battery contact assembly to a device.

20. The method according to claim 19, wherein the first attachment mechanism includes one or more protrusions for a snap fit into a receiving structure in the device.
